(19) United States
(12) Patent Application Publication
(10) Pub. No.: US 2024/0384703 A1
(43) Pub. Date: Nov. 21, 2024

(54) WIND TURBINE TOWER INSTALLATION APPARATUS AND METHOD

(71) Applicant: Nekkar ASA, Kristiansand S (NO)

(72) Inventors: Ricardo Nuno Correia, Flekkerøy (NO); Yngvar Borø, Søgne (NO); Adrian Mihai Orasanu, Flekkerøy (NO); Arild Andersen, Kristiansand (NO)

(73) Assignee: Nekkar ASA, Kristiansand S (NO)

(21) Appl. No.: 18/576,910

(22) PCT Filed: Jun. 22, 2022
(86) PCT No.: PCT/NO2022/050143

§ 371 Date: Jan. 5, 2024

(30) Foreign Application Priority Data
Jul. 7, 2021 (NO) 20210881

(51) Int. Cl. F03D 13/20; B66C 23/28; E04H 12/34

(52) U.S. Cl. CPC F03D 13/201; B66C 23/28; E04H 12/342

(57) ABSTRACT

A wind turbine tower installation apparatus and methods of erecting a wind turbine tower are disclosed. The wind turbine tower installation apparatus is arranged for installing a tower has a plurality of longitudinally stackable sections. The apparatus has a frame comprising a guide for positioning the apparatus on an installed tower portion, a platform for supporting wind turbine components on the frame, and a mechanism for transversely positioning the supported wind turbine component in alignment with the tower. A lifting mechanism is provided for moving the apparatus longitudinally up and down the installed tower portion. The apparatus further has a yaw control thruster mounted to the frame and configured to provide a counter acting force to rotational wind loads in use.

### CROSS-REFERENCE TO RELATED APPLICATIONS

This application is the U.S. national stage application of International Application No. PCT/NO2022/050143, filed Jun. 22, 2022, which international application was published on Jan. 12, 2023 as WO 2023/282757 in the English language. The International Application claims priority to Norwegian patent application No. 20210881, filed Jul. 7, 2021. The international application and Norwegian application are both incorporated herein by reference, in their entirety.

### FIELD

The present invention relates to a wind turbine tower installation apparatus and methods of erecting a wind turbine tower.

### BACKGROUND

The invention relates to the technical field of wind turbines, and more specifically to the installation and construction of wind turbines.

For increased efficiency it is desirable to provide wind turbines with larger rotor areas (to increase the capacity of the turbine) and to position the turbine at a higher elevation (as wind speeds typically increase with altitude and wind is subject to less disruption). As such, there is a trend towards building wind turbines with towers having much greater length. Further, the growth of offshore wind turbines is an additional driving factor towards larger and taller wind turbines.

As wind turbines grow taller the installation process becomes more challenging such that there is a need for effective methods and apparatus for successful installation of tall wind turbines. Conventionally, the wind turbine tower is constructed of a series of longitudinally stackable tubular sections which must be placed and secured end on end. The assembly process therefore comprises first installing a base section of the tower (for example embedded on a platform or foundation) before installing the tower sections in sequence followed by a nacelle and blades on the final section. This installation is carried out using extremely large cranes, but the size of the cranes is such that significant work and infrastructure is required to merely position and install the cranes before work can commence on the wind turbine itself. For example delivery of the parts of a crane to an installation site may require some 80 semi-trailers. Furthermore, it may be very challenging, and require acceptable weather conditions, to install parts of the wind turbine, particularly the uppermost parts, when they are lifted by a crane separate from the tower, for example because of relative movement of the crane and the tower.

Accordingly, the applicant has proposed (in their co-pending Norwegian patent applications NO20201367, NO20201368, NO20201369 all having a filing date of 11 Dec. 2020) an apparatus and method for performing parts of an operation to install a tower for a wind turbine in which an apparatus comprising a travelling car for travelling up and down along an installed tower section of the wind turbine and for carrying an item to be installed as part of the wind turbine. This apparatus and method provides significant potential advantages over the conventional, crane based, methods of installation. Embodiments of the invention seek to provide further improvements and/or alternatives to the apparatus and method.

### SUMMARY

According to a first aspect of the invention, there is provided a wind turbine tower installation apparatus, for installing a tower comprising a plurality of longitudinally stackable sections, wherein the apparatus comprises: a frame comprising a guide for positioning the apparatus on an installed tower portion, a platform for supporting wind turbine components on the frame, and a mechanism for transversely positioning the supported wind turbine component in alignment with the tower; and a lifting mechanism for moving the apparatus longitudinally up and down the installed tower portion; the apparatus being characterised by further comprising: a yaw control thruster mounted to the frame and configured to provide a counter acting force to rotational wind loads in use.

The applicant has recognised that rotational loading of the wind turbine installation apparatus can potentially be a significant constraint on the safe operation of the apparatus. In use (particularly for example when loaded with a component of the wind turbine) wind will act upon the side of the apparatus and urge it to yaw, i.e. rotate about the longitudinal axis of the installed tower portion (which is generally the vertical direction). This loading may be both hazardous and cause difficulties in precise handling and alignment of wind turbine components. A safe weather condition operational window must be defined when assembling large structures such as wind turbines and the yaw loading of the apparatus will be one of the factors which must be considered. In order to maximise the operating window the weight of the apparatus must be selected to provide stability across the full operating range. Likewise the maximum operating performance (for example lifting speed and/or maximum load capacity) must also be determined taking into account the operating range. Advantageously, the provision of a yaw control thruster in accordance with embodiments may enable the operating window to be expanded and/or the weight of the apparatus to be reduced and/or the load capacity to be increased. Thus, embodiments of the invention may increase the utilisation of the apparatus and may enable reduced assembly times for the wind turbine.

The thruster may be a rotor. For example, the rotor may be a bladed propeller (for example having 1 or a plurality of blades). The thruster may comprise a shroud. A shroud may for example protect the rotor from damage by foreign objects and also reduce the safety risk posed from the rotating blades. The rotor may be rotatably mounted within the shroud. Alternatively the thruster could be a nozzle for example a nozzle for the exhaust of a source of thrust ducted from another location (for example air ducted from a fan mounted remote from the thruster).

The thruster may be mounted at a transverse end of the frame. It may be appreciated that the counter-force of the thruster is a moment acting about the axis of the tower. As such, it is advantageous to position the thruster at transverse extremity of the apparatus. The apparatus may, for example, include a counter-balance mechanism such that the frame extends transversely away from the tower to a greater extent on the counter-balance carrying side than the load carrying side. The thruster may be positioned on an end of the frame outwardly of the counter-balance mechanism (which may provide the maximum distance between the axis of rotation—the tower axis—and the thruster).

The frame may comprise first and second side beams, configured to extending along opposing sides of the tower. The side beams may for example be support trusses. The frame may, for example be constructed in two interconnectable halves which can be joined around the tower. A pair of spaced apart yaw control thruster may be mounted to adjacent ends of the first and second side beams.

The (or each) thruster may be pivotally connected to the frame. This may for example enable the thruster to be rotated between a stowed position and an extended position. In the stowed position the thruster may be positioned inward of the end of the frame. This may for example provide protection and/or reduced space requirement during transportation.

The apparatus may further comprise a yaw control thruster controller. The controller may be configured to receive data from at least one yaw control sensor and provide control signals to the yaw control thruster. The at least one yaw control sensor may include at least one motion reference unit connected to the frame of the apparatus. Alternatively or additionally, sensors may be provided on the tower, for example at the top of the already installed section of the tower. The motion reference unit may provide an inertial measurement unit with single or multi-axis motion sensors (for example MEMS gyroscopes and/or accelerometers). The controller may also be provided with the position of the apparatus, for example the position relative to the tower. The controller may be further provided with wind data measurements. For example, the apparatus may include at least one wind sensor to detect wind strength and/or direction. The wind sensor may be mounted to the frame or to the installed tower. The controller may also receive weather forecast information, for example forward weather estimation data.

In some embodiments the yaw control thruster may also be used to react to movement of the tower during use. For example, the thruster could optionally provide a counter thrust force to swaying of the tower during installation. This may be particularly useful for damping potentially damaging harmonic oscillations of the tower.

The apparatus may include a power source. The same power-source may be used for movement and actuation of the apparatus and to supply power to the (or each) thruster). For example, the apparatus may comprise a power container mounted to the frame. The power container may contain a battery, for example a lithium battery system. The power container may additionally or alternatively include a generator.

According to a further aspect of the invention there is provided a method of erecting a wind turbine tower, the method comprising the steps of: installing a tower section;

attaching a moveable installation apparatus to the installed tower section for supporting and positioning subsequent tower sections; detecting wind loading on the moveable installation apparatus; and applying counter-acting thrust to the moveable installation apparatus to compensate for yaw loads caused by the wind loading.

The counter-acting thrust may be applied via a thruster mounted to the moveable installation apparatus. The method may comprise counter-acting rotation of the moveable installation apparatus about the axis of the installed tower.

The method may further comprises using weather forecast data to enhance the yaw load compensation.

The method may comprises modifying the safe operating window of the moveable installation apparatus based upon yaw load compensation. For example, the apparatus could be provided with a first operating window for operation without yaw load compensation and a second operating window for operation with yaw load compensation.

Unless otherwise stated, each of the integers described may be used in combination with any other integer as would be understood by the person skilled in the art. Further, although all aspects of the invention preferably “comprise” the features described in relation to that aspect, it is specifically envisaged that they may “consist” or “consist essentially” of those features outlined in the claims. In addition, all terms, unless specifically defined herein, are intended to be given their commonly understood meaning in the art.

Whilst the invention has been described above, it extends to any inventive combination of the features set out above or in the following description or drawings.

### BRIEF DESCRIPTION OF THE DRAWINGS

Embodiments of the invention may be performed in various ways, and embodiments thereof will now be described by way of example only, reference being made to the accompanying drawings, in which:

FIGS. 1 to 14 illustrate parts of an operation to install a wind turbine which may incorporate embodiments of the invention;

FIGS. 15 to 20 illustrate apparatus and methods in accordance with embodiments of the invention.

### DETAILED DESCRIPTION OF THE EMBODIMENTS

Note that the embodiments shown in the figures are mere examples of the invention, and that they are not necessarily drawn to scale. Other embodiments being configured differently from those shown in the figures may be within the scope of the invention according to the claims.

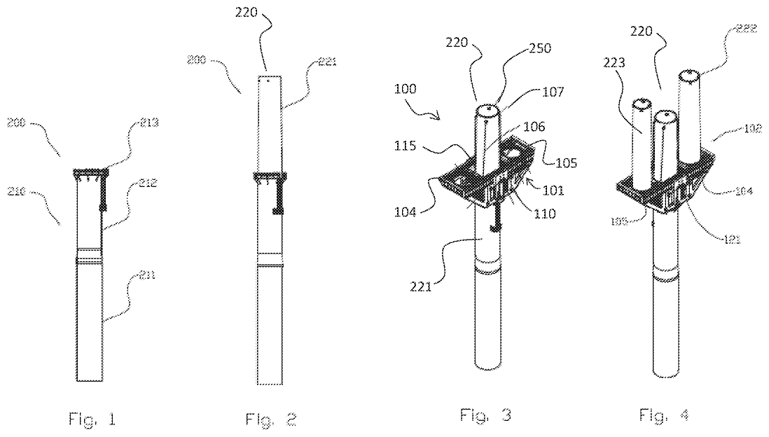

As noted above, the applicant has proposed an apparatus and method for performing parts of an operation to install a tower for a wind turbine. This apparatus and method will be briefly described with reference to FIGS. 1 to 14. These illustrations show a wind turbine at different points in time during installation. It will be appreciated that the steps shown are not considered limiting on the present invention but are provided for reference.

FIG. 1 shows an example of a base 210 for a wind turbine 200. The base 210 typically comprises a foundation piece 211 and a transition piece 212. The transition piece 212 includes a base working platform 213. Methods in accordance with embodiments of the invention may include the step of providing the base 210 or, alternatively, the base 210 may be of another type, e.g. any other type of base known from the prior art. For example, the provision of a foundation 211 and transition 212 pieces may be typically in an offshore foundation but may not be required in other installations. The first tower section in a land-based installation may, for example, be directly bolted to a concrete foundation. It will thus, be appreciated that embodiments are applicable to both land and offshore applications. FIG. 2 shows the same wind turbine 200, with the addition of a first, base, section 221 of the tower 220 of the wind turbine 200. It may be appreciated the tower 220 of the wind turbine 200 comprises a plurality of such sections which are longitudinally stackable to form the full length of the tower 220. The base section 221 may typically, but not necessarily, be installed atop the transition piece 212 by use of a crane device (not shown).

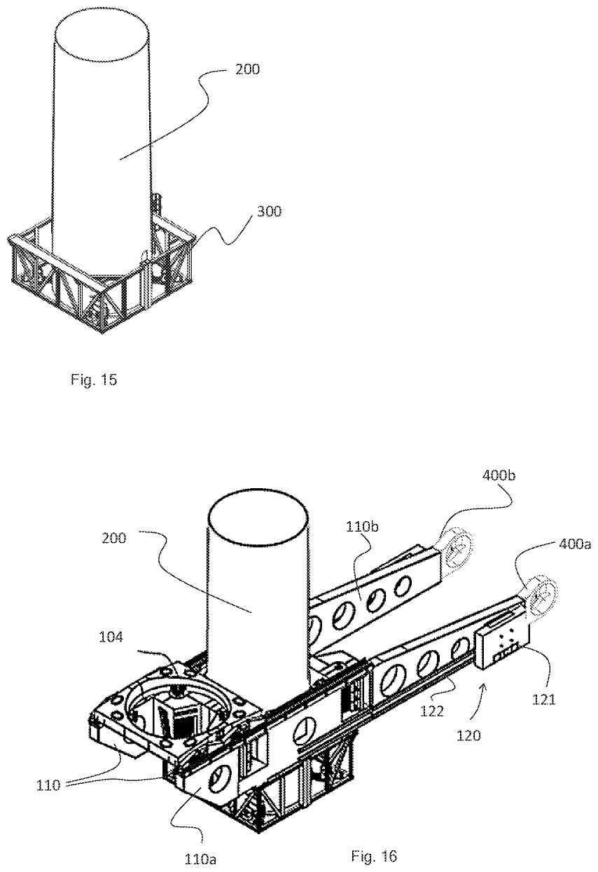

As shown in FIG. 3, once a first tower section 221 has been installed, an installation apparatus 100 in accordance with embodiments may be connected to the tower 220. The apparatus 100 will be described in further detail below but generally comprises a movable portion, referred to herein as a “travelling car” 101, which travels up and down along the longitudinal axis of the tower. The travelling car 101 is carried on load bearing ropes 106 which are attached to a set of lifting lugs 107 provided at, or proximal, to the free end 250 of the installed section 221 of the tower 220. One or more winches are provided on the travelling car 101 to act upon the ropes 106. Prior to the installation of the travelling car 101, a landing frame 300 (as shown in FIG. 15) or resting flange may be installed on the tower 220 or base 210 to provide a fixed base for the travelling car.

The travelling car 101 comprises a frame 110 defining a generally horizontal platform 102 (see FIG. 4) which extends transversely beyond the tower 220. A central portion of the frame 110 surrounds the installed tower section 221 and provides a guide 115 for positioning the apparatus 100. The guide 115 may, for example, include wheels or rollers (not shown) which engage and move along the outer surface of the tower section 221. The apparatus 100 further includes a mechanism for transversely positioning supported wind turbine components in alignment with the tower (i.e. for moving the component or components laterally along the platform 102). In the embodiment of FIGS. 1 to 15, two such transverse positioners 104, 105 are provided. Each of the first and the second transverse positioner 104, 105 are configured for carrying an item to be installed as part of the wind turbine 200. The travelling car 101 may further include a counter-balance device 120 for balancing the travelling car 101. The counter-balance device 120 (best seen in FIG. 16) may include at least one weight 121 moveably mounted on a track 120 associated with the frame 110 such that the weight may be moved transversely to counter the weight of components carried on the travelling car 101.

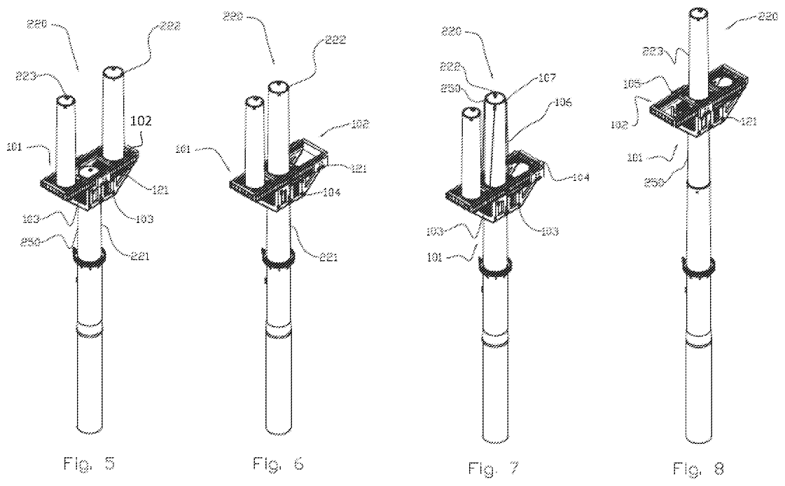

In FIG. 4, a first and a second subsequent sections 222, 223 for the tower 220 have been secured respectively on the first and the second transverse positioners 104, 105 of the platform 102 (with the transverse positioners in their initial positions). A crane may for example be used to load the sections onto the apparatus 100. As shown in FIG. 5, the travelling car 101, carrying the first and the second sections 222, 223, moves to an elevated position. In this elevated position, the deck 102 is slightly above the uppermost installed section of the tower 250.

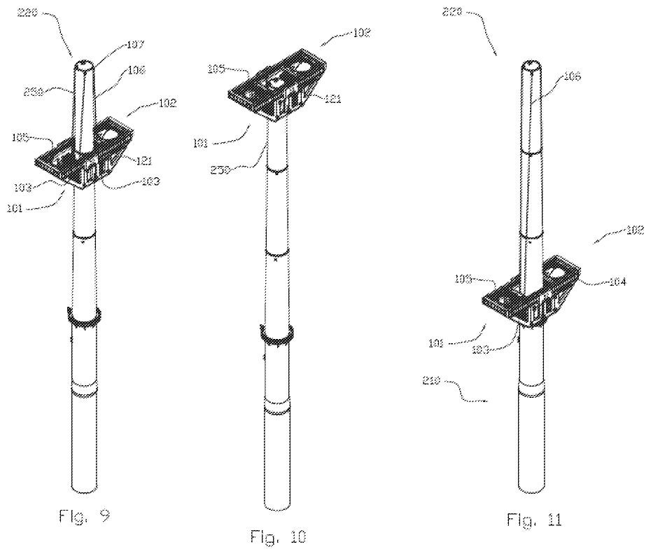

Subsequently, in FIG. 6, the first transverse positioner 104 of the deck 102 has moved to a central position of the travelling car 101 to transversely position its supported wind turbine component directly above the uppermost installed section (base section 221) of the tower 220. To balance the travelling car 101 after/while moving the first section 222 to the central position, the weight 121 of the counter-balancing device 120 has been moved to the side of the travelling car 101 where the first section 222 was held prior to it being moved centrally. Moving the weight 121 in the opposite direction of the first section 222, offsets an imbalance that would otherwise have been caused by the movement of the first section 222. The tower section 221 and 222 may then be secured together (as will be described in further detail below).

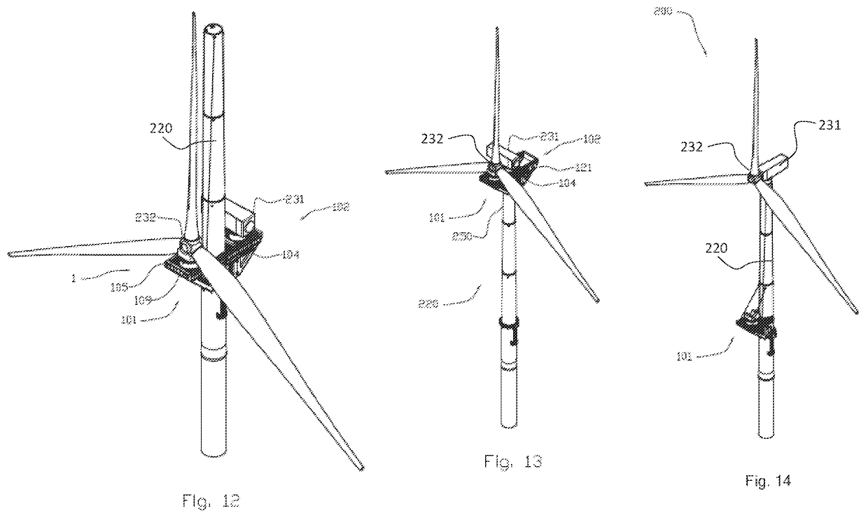

As can be further seen in FIG. 7, after installing the section 222 the lifting lugs 107 and the ropes 106 of the lifting mechanism are moved to the upper end of the installed portion. Thus, the winches 103 of the lifting mechanism may be used to move the travelling car 101 longitudinally along the next section. This enables the positioning and connection of the next section 223 to be installed in substantially the same manner as section 222 and as shown in FIG. 8.

Once the final tower section is installed (in this case 223) the lifting mechanism is again attached to the upper end of the installed tower section, as shown in FIG. 9. The travelling car 101 is then able to move longitudinally along the tower 220 between the upper end (the position shown in FIG. 10) and its landing frame, which, as shown in FIG. 11, may be at the connection between the tower 220 and base 210.

As shown in FIGS. 12 to 14, with the tower fully erected the installation apparatus 100 may be used to install subsequent wind turbine components. For example, the apparatus may be used for the installation of a nacelle 231 and a rotor 232. As shown in FIG. 12 the nacelle 231 and rotor 232 may be mounted on the travelling car 101 for lifting longitudinally along the tower 220. In FIG. 13, the travelling car 101 has been moved to the top of the tower 220 and the transverse positioners 104, 105 may be used to position the nacelle 231 and rotor 232. When the propeller with rotor blades 232 has been installed, the wind turbine 200 may be fully installed, or the part of the installation of the wind turbine 200 that involves use of the apparatus 100 may be completed as shown in FIG. 14.

The installation apparatus 100 is shown in further detail in FIGS. 15 and 16. FIG. 15 shows the landing frame 300 for the travelling car 101. The landing frame 300 may typically be configured for supporting the travelling car 101 when the travelling car is sitting at the base 210 of the wind turbine 200, for example when installing the travelling car 101 onto the tower or when the apparatus 100 is not in use.

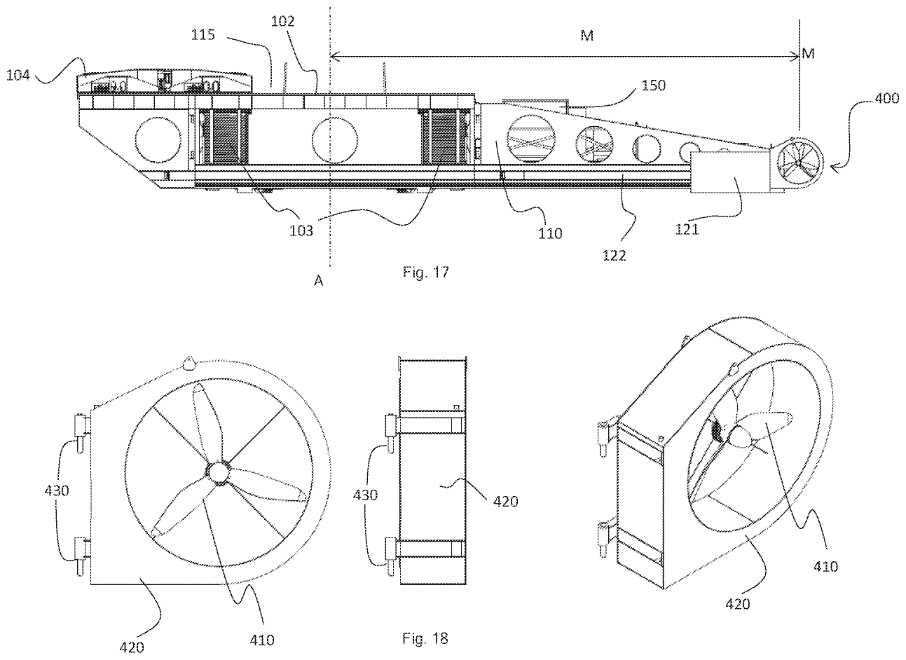

FIGS. 16 and 17 shows a detailed embodiment of the travelling car 101. The travelling car comprises a frame 110 which is formed from two side support trusses 110a and 110b which extend transversely along opposing sides of the tower. The frame 110 is constructed in two interconnectable halves which can be joined around the tower in use. The upper plane of the frame 110 defines the platform onto which is mounted at least one transverse positioning mechanism 104. It may also be noted that external sides of the frame 110 mounts the counter-balance system 120 with a weight 121 on rails 122. In accordance with embodiments of the invention, the apparatus 100 also includes a pair of yaw control thrusters 400a and 400b mounted on respective side frame 110a, 110b of the travelling car 101.

FIG. 17 shows an enlarged side view of the travelling car 101 of FIG. 16. Whilst only one thruster 400 is fully visible in the figure it may be noted that the rotor of a second, substantially identical, thruster is partially visible behind the thruster at the at the front side of the apparatus in the figure. Each yaw control thruster 400 is conveniently mounted to a transverse end of the frame 110 of the travelling car 101. The yaw control thruster 400 is transversely outward of the counter-balance weight system 120. The positioning of the thruster 400 at the end of the frame 110 ensures that the thruster 400 may have generally unobstructed airflow across its rotor 410 and ensures that the moment arm M of the thruster 400 is maximised. The moment arm M is defined as the distance between the thruster 400 and the central axis A of the tower to which the travelling car is mounted in use (which it will be appreciated corresponds to the centre line of the guide 115 defined by the frame 110). The connection between the frame 110 and the thruster 400 is a pivotable connection such that the thruster may be rotated between a stowed position and an extended position (the position of the figure). As can be noted from FIG. 18, the pivot is provided on an inward edge of the thruster 400 such that the thruster is rotated inwardly of the frame to stow alongside the end portion of the frame. The stowed position reduces the total length of the traveling car 101 (for example for transportation) and may also provide some protection to the thruster 400.

The thruster 400 will be described in further detail with reference to the isolated views of FIG. 18. The thruster 400 comprises a rotor 410, which in the illustrated example is a three bladed rotor. The rotor is enclosed in a shroud 420 which protects and supports the rotor 410 in use. The shroud 420 includes pivot connections 430 on the side proximal to the frame 110 of the travelling car 101 which enable the thruster to be mounted on the frame 110.

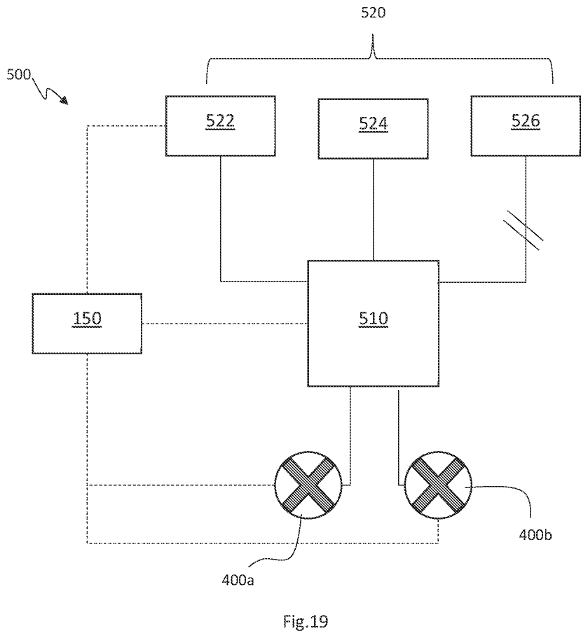

The apparatus in accordance with embodiments may further comprise a control system 500 for the thruster 400 as shown schematically in FIG. 19. The control system 500 and both thrusters 400a 400b may be powered from a power source 150 mounted on the frame 110 of the travelling car. This power source 150 may be a centralised power source which also, for example, provides power to the winches 103 of the lifting mechanism (and associated controls). The control system 500 has a has yaw control thruster controller 510. It will be appreciated that the controller 510 may be a dedicated controller or may be integrated into other systems on the wind turbine installation apparatus 1 (for example being integrated into a general-purpose apparatus control system).

The controller 510 is in communication with a number of inputs 520 including at least one at least one yaw control sensor. Sensor 522 is a motion reference unit mounted on the travelling car 101. Motion reference units are commercially available and provide an inertial measurement unit with single or multi-axis motion sensors (for example MEMS gyroscopes and/or accelerometers). In some embodiments a further motion reference unit may also be provided on the tower 220. Sensor 524 is a wind sensor which detects the wind direction and speed. The sensor 524 could be mounted on either the tower 220 or the traveling car 101. Input 526 provides the controller with weather information such as a forward forecast or estimation of wind conditions at the tower 220. It may be appreciated that the weather information input 526 may for example be from a remote location such as a networked computer. The controller 510 is also in communication with the thrusters 400a and 400b provided on each side frame 110a, 110b of the travelling car 101. The controller 510 uses the inputs 520 to calculate the loading (and/or anticipated loading) on the travelling car 101 during use as a result of wind forces which are urging the car to yaw about the axis of the tower 220. The controller 510 determines the required direction and quantum of the thrust to be provided by the thrusters 400 to counter the yaw force. The controller then commands the rotors 410 or the thrusters to output the required counter thrust. The thrust may alleviate or remove the rotational force in the travelling car 101. With the thrusters 410 active the controller 510 can provide continuous or intermittent feedback control using the inputs 520.

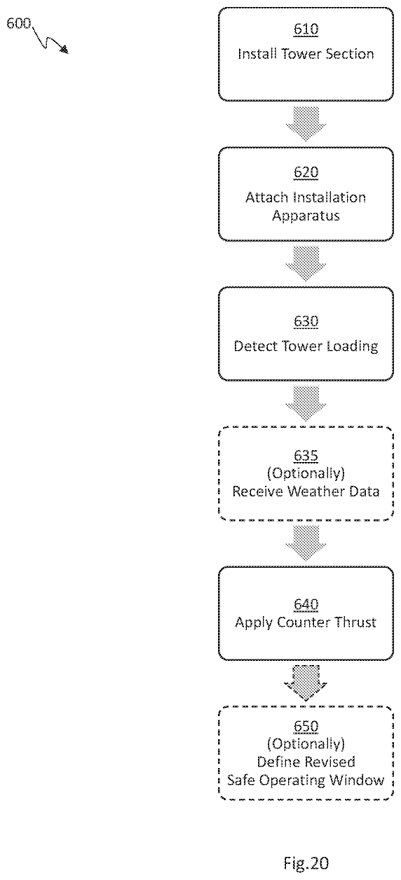

The method according to embodiments of the invention is shown schematically in FIG. 20. The method 600 includes the initial step 610 of installing a tower section followed by the step 620 of attaching an installation apparatus to the tower section. These steps may be generally as described above with reference to FIGS. 1 to 14. The method further comprises the step 630 of detecting wind loading on the moveable installation apparatus, for example by using sensors connected to a control system as described with reference to FIG. 19. Optionally, the method may also include the step 635 of receiving weather data which can be integrated with the senor data from step 630 to improve the control output. The method then comprises the step 640 of applying a counter-thrust, for example using a thruster 400 as shown in FIG. 18, to compensate for yaw loading of the installation apparatus. The counter-thrust may counter act, cancel, or alleviate loads on the apparatus that are caused by wind impinging the side faces of the apparatus. Typically, there may be a defined safe operating window with respect to weather conditions in which installation or erecting of a wind turbine can be safely carried out. As such, embodiments may also include the optional step 650 of defining a revised safe operating window for use of the installation apparatus when operating with a yaw control arrangement in accordance with methods or apparatus of embodiments. For example, separate safe operating windows may be defined for the apparatus when operational with or without the yaw control system and method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

Although the invention has been described above with reference to preferred embodiments, it will be appreciated that various changes or modification may be made without departing from the scope of the invention as defined in the appended claims.

1. A wind turbine tower installation apparatus for installing a tower comprising a plurality of longitudinally stackable sections, wherein the apparatus comprises:
a frame comprising
a guide for positioning the apparatus on an installed tower portion,
a platform for supporting wind turbine components on the frame, and
a mechanism for transversely positioning the supported wind turbine component in alignment with the tower;
a lifting mechanism for moving the apparatus longitudinally up and down the installed tower portion; and
a yaw control thruster mounted to the frame and configured to provide a counter acting force to rotational wind loads in use.

2. The wind turbine tower installation apparatus as claimed in claim 1, wherein the thruster comprises a rotor.

3. The wind turbine tower installation apparatus as claimed in claim 2, wherein the thruster further comprises a shroud, the rotor being rotatably mounted within the shroud.

4. The wind turbine tower installation apparatus as claimed in claim 1, wherein the thruster is mounted at a transverse end of the frame.

5. The wind turbine tower installation apparatus as claimed in claim 1, wherein the frame comprises first and second side beams, configured to extending along opposing sides of the tower, and wherein a pair of spaced apart yaw control thruster are mounted to adjacent ends of the first and second side beams.

6. The wind turbine tower installation apparatus as claimed in claim 1, wherein the, or each, thruster is pivotally connected to the frame.

7. The wind turbine tower installation apparatus as claimed in claim 1, further comprising a yaw control thruster controller configured to receive data from at least one yaw control sensor and provide control signals to the yaw control thruster.

8. The wind turbine tower installation apparatus as claimed in claim 7, wherein the at least one yaw control sensor includes at least one motion reference unit connected to the frame of the apparatus.

9. The wind turbine tower installation apparatus as claimed in claim 7, wherein the controller receives forward weather estimation data.

10. A method of erecting a wind turbine tower, the method comprising the steps of:
installing a tower section;
attaching a moveable installation apparatus to the installed tower section for supporting and positioning subsequent tower sections;
detecting wind loading on the moveable installation apparatus; and
applying counter-acting thrust to the moveable installation apparatus to compensate for yaw loads caused by the wind loading.

11. The method of claim 10, wherein the counter-acting thrust is applied via a thruster mounted to the moveable installation apparatus.

12. The method of claim 10, wherein the method comprises counter-acting rotation of the moveable installation apparatus about the axis of the installed tower.

13. The method of claim 10, wherein the method further comprises using weather forecast data to enhance the yaw load compensation.

14. The method of claim 10, wherein the method further comprises modifying the safe operating window of the moveable installation apparatus based upon yaw load compensation.

15. The wind turbine tower installation apparatus as claimed in claim 2, wherein the thruster is mounted at a transverse end of the frame.

16. The wind turbine tower installation apparatus as claimed in claim 3, wherein the thruster is mounted at a transverse end of the frame.

17. The wind turbine tower installation apparatus as claimed in claim 2, wherein the frame comprises first and second side beams, configured to extending along opposing sides of the tower, and wherein a pair of spaced apart yaw control thruster are mounted to adjacent ends of the first and second side beams.

18. The wind turbine tower installation apparatus as claimed in claim 3, wherein the frame comprises first and second side beams, configured to extending along opposing sides of the tower, and wherein a pair of spaced apart yaw control thruster are mounted to adjacent ends of the first and second side beams.

19. The wind turbine tower installation apparatus as claimed in claim 4, wherein the frame comprises first and second side beams, configured to extending along opposing sides of the tower, and wherein a pair of spaced apart yaw control thruster are mounted to adjacent ends of the first and second side beams.

20. The wind turbine tower installation apparatus as claimed in claim 2, wherein the, or each, thruster is pivotally connected to the frame.
